(19) United States
(12) Patent Application Publication
(10) Pub. No.: US 2017/0239679 A1
(43) Pub. Date: Aug. 24, 2017

(54) SYSTEM AND METHOD HAVING FILTER DISPOSED IN FLUID SUPPLY CUP

(71) Applicant: Carlisle Fluid Technologies, Inc., Scottsdale, AZ (US)

(72) Inventors: William K. Bierie, Liberty Center, OH (US); Marvin D. Burns, Millbury, OH (US)

(21) Appl. No.: 15/432,734

(22) Filed: Feb. 14, 2017

Related U.S. Application Data
(60) Provisional application No. 62/298,928, filed on Feb. 23, 2016.

(51) Int. Cl. B05B 15/00; B05B 1/02; B01D 35/027; B01D 35/30; B05B 7/24; B01D 29/96

(52) U.S. Cl. CPC B05B 15/008; B05B 7/2489; B01D 29/96; B01D 35/027; B01D 35/306; B05B 1/02; B01D 2201/167

(57) ABSTRACT

A system is provided for a cup used to supply a liquid to a spray tool. The system may include a cup, a filter configured to mount inside of the cup, one or more supports extending across the filter, and a retainer configured to retain the filter.

### CROSS REFERENCE TO RELATED APPLICATION

This application claims priority to and benefit of U.S. Provisional Patent Application No. 62/298,928, entitled “SYSTEM AND METHOD HAVING FILTER DISPOSED IN FLUID SUPPLY CUP,” filed Feb. 23, 2016, which is herein incorporated by reference in its entirety.

### BACKGROUND

The invention relates generally to spray tools and, more specifically, container assemblies for spray tools.

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

Spray tools are used to apply a spray coating to a wide variety of target objects. Unfortunately, coating materials may include particles that can clog, reduce flow, and reduce performance of the spray tools. Once clogged, the spray tools may be taken out of service for cleaning and repair. Although the coating materials may be pre-filtered prior to use with the spray tools (e.g., during a separate mixing process completely separate from the spray tools), it is still possible for contaminants and particles to enter and/or form in the coating materials. Therefore, a need exists for an improved filtration system for spray tools.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a cup, a filter configured to mount inside of the cup, and a first retainer configured to retain the filter.

In a second embodiment, a system includes a filter configured to mount inside of a cup, and a first retainer configured to retain the filter.

In a third embodiment, a system includes a filter, one or more supports extending across the filter, a vent tube opening through the filter, and a first retainer configured to retain the filter.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram illustrating an embodiment of a spray coating system having a gravity feed container assembly;

FIG. 2 is a flow chart illustrating an embodiment of a spray coating process utilizing the gravity feed container assembly of FIG. 1;

FIG. 3 is a cross-sectional side view of an embodiment of a spray tool coupled to the gravity feed container assembly of FIG. 1;

FIG. 4 is a cutaway exploded perspective view of an embodiment of the gravity feed container assembly of FIG. 3, illustrating a lid, a filter assembly, and a cup prior to assembly;

FIG. 5 is a cross-sectional exploded side view of an embodiment of the gravity feed container assembly of FIG. 3;

FIG. 6 is a cross-sectional side view of an embodiment of the gravity feed container assembly of FIG. 3, illustrating the lid, the filter assembly, and the cup after assembly, with the filter assembly removably mounted inside of the cup and outside of the lid;

FIG. 7 is a partial cross-sectional view of an embodiment of the gravity feed container assembly of FIG. 6 taken within line 7-7, illustrating a coupling between the lid and the cup, and the filter assembly retained inside of the cup and outside of the lid by a first fastener having at least one snap fit structure;

FIG. 8 is a partial cross-sectional view of an embodiment of the gravity feed container assembly of FIG. 7 taken within line 8-8, illustrating details of the first retainer having the at least one snap fit structure with one or more protrusions disposed in one or more recesses;

FIG. 9 is a partial cross-sectional view of an embodiment of the gravity feed container assembly of FIG. 6 taken within line 7-7, illustrating the filter assembly removably mounted inside of the cup and outside of the lid, wherein the filter assembly includes a first retainer having a friction fit interface along a first portion and/or a second portion, and the second portion extends toward an opening of the cup;

FIG. 10 is a partial cross-sectional view of an embodiment of the gravity feed container assembly of FIG. 9, illustrating the filter assembly removably mounted inside of the cup and outside of the lid, wherein the second portion of the first retainer has a plurality of protrusions and/or recesses that mate with a corresponding smooth surface or a non-smooth surface (e.g., with a plurality of mating recesses and/or protrusions) to create a snap fit structure;

FIG. 11 is a partial cross-sectional view of an embodiment of the gravity feed container assembly of FIG. 9, illustrating the filter assembly removably mounted inside of the cup and outside of the lid, wherein the filter assembly includes the first retainer and a separate second retainer; and

FIG. 12 is a partial cross-sectional view of an embodiment of the gravity feed container assembly of FIG. 9, illustrating the filter assembly removably mounted inside of the cup and outside of the lid, wherein the filter assembly includes the first retainer having the second portion extending away from the opening of the cup.

### DETAILED DESCRIPTION

As described in detail below, a gravity feed container assembly is provided to filter the liquid coating material such as paint. In particular, embodiments of the container assembly include a filter recessed into a container or cup. For example, the container assembly may include a lid and a filter that is removably mounted inside of the cup and outside the lid. The filter is removably mounted to allow for re-filling of the cup with paint. The filter is recessed into the cup so it may create less mess when pouring the paint out of the cup, and this may allow a storage lid to be attached to the cup with the filter still in place. In some embodiments, the filter may have a feature such as a tab or extended rib that allows for easy removal.

As discussed below, the disclosed embodiments provide a filter assembly (e.g., a filter and one or more retainers, support structures, gripping structures, tube openings, etc.) that is configured to mount inside of a cup or main container portion of a container assembly, while being positioned outside of a lid or cover portion of the container assembly so as to not interfere with the lid. For example, the filter assembly may be retained within the cup by one or more retainers, such as a snap-fit structure (e.g., protrusions in recesses), a friction fit, a clamp, a removable fastener, or any combination thereof. The filter assembly may be recessed below a main opening into the cup, and may rest or be supported by an annular shoulder inside the cup below the main opening. The filter assembly may be designed to specifically fit within a particular cup, or the filter assembly may be designed to universally fit or retrofit within a variety of pre-existing cups (e.g., via the retainers). By retaining the filter assembly in the cup rather than the lid, the lid may be designed with a lower profile, the filter assembly may have greater retention in the cup due to greater space and retention options, and the lid may accept a variety of containers with different filter assemblies while maintaining a particular coupling between the cup and lid. Furthermore, by retaining the filter assembly in the cup rather than the lid, the lid may be a non-disposable component (e.g., unlimited uses with the exception of long term wear, damage, etc.), while the cup and filter assembly are disposable components (e.g., limited number of uses such as 1, 2, 3, 4, 5, 6, 7, 8, 9, or 10 uses). In addition, a plurality of different filter assemblies may be constructed with different filtering characteristics (e.g., filtering different sized particles), designed for different fluids (e.g., water based paints, solvent based paints, stains, etc.), different filtering materials (e.g., membranes, paper, fabric, plastic, metal, or any combination thereof), different thicknesses, different retainers (e.g., snap fit, friction fit, clamp, etc.), or any combination thereof. Although the following discussion presents the filter assembly and container assembly in context of gravity feed spray tools, the disclosed embodiments may be used with any type of spray tool having a container assembly mounted thereto. For example, the disclosed embodiments may be used with siphon feed spray tools, which may have the container assembly coupled to a fluid inlet along a bottom portion of a spray tool, and use a vacuum due to gas (e.g., air) flow through the spray tool to suction the fluid flow into the spray tool from the container assembly.

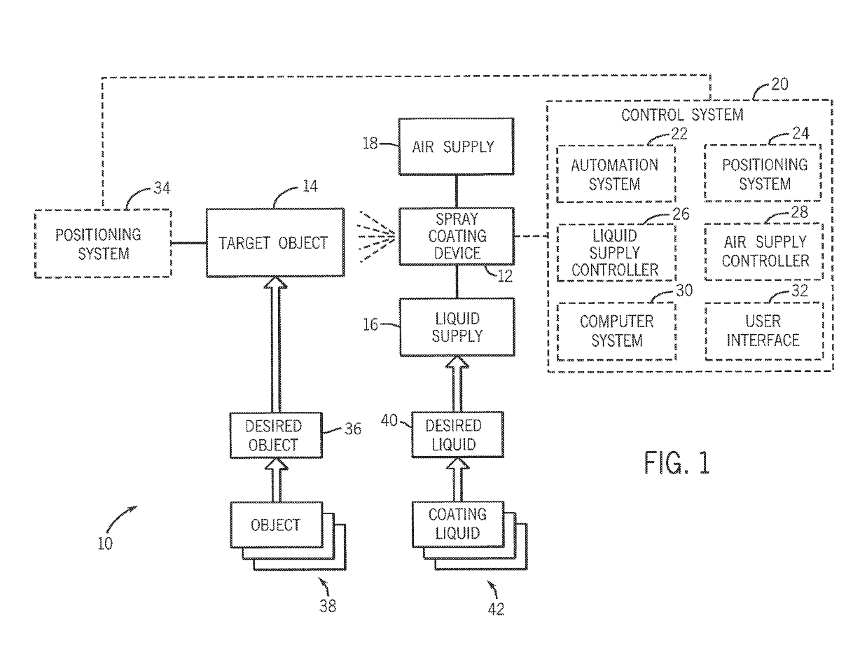

Turning now to the drawings, FIG. 1 is a flow chart illustrating a spray coating system 10, which comprises a spray tool 12 for applying a desired coating liquid to a target object 14. The spray tool 12 may be coupled to a variety of supply and control systems, such as a liquid supply 16, an air supply 18, and a control system 20. As discussed in detail below, the liquid supply 16 may include a container assembly having a lid or cover coupled to a cup or container portions, wherein a filter assembly is disposed inside the cup and outside of the lid. For example, the filter assembly may include a filter and one or more retainers that retain the filter inside the cup below a main opening into the cup. The control system 20 facilitates control of the liquid and air supplies 16 and 18 and ensures that the spray tool 12 provides an acceptable quality spray coating on the target object 14. For example, the control system 20 may include an automation system 22, a positioning system 24, a liquid supply controller 26, an air supply controller 28, a computer system 30, and a user interface 32. The control system 20 may also be coupled to a positioning system 34, which facilitates movement of the target object 14 relative to the spray tool 12. Accordingly, the spray coating system 10 may provide a computer-controlled mixture of coating liquid, liquid and air flow rates, and spray pattern.

The spray coating system 10 of FIG. 1 is applicable to a wide variety of applications, liquids, target objects, and types/configurations of the spray tool 12. For example, a user may select a desired liquid 40 from a plurality of different coating liquids 42, which may include different coating types, colors, textures, and characteristics for a variety of materials such as metal, plastic, ceramic, and wood. The user also may select a desired object 36 from a variety of different objects 38, such as different material and product types. The spray tool 12 may include a liquid coat spray tool (e.g., applies a liquid coating material) having a variety of different components and spray formation mechanisms to accommodate the target object 14 and liquid supply 16 selected by the user. For example, the spray tool 12 may include an electrostatic spray tool, a rotary atomizer spray tool (e.g., a rotary bell cup spray tool), an airless or hydraulic atomizer spray tool (e.g., atomizes coating material without a gas), an air-assisted or pneumatic atomizer spray tool (e.g., atomizes coating material with assistance of a gas such as air), a gravity fed spray tool (e.g., with a gravity feed container disposed above and coupled to the spray tool), a siphon feed spray tool (e.g., with a siphon feed container disposed below and coupled to the spray tool), or any combination thereof.

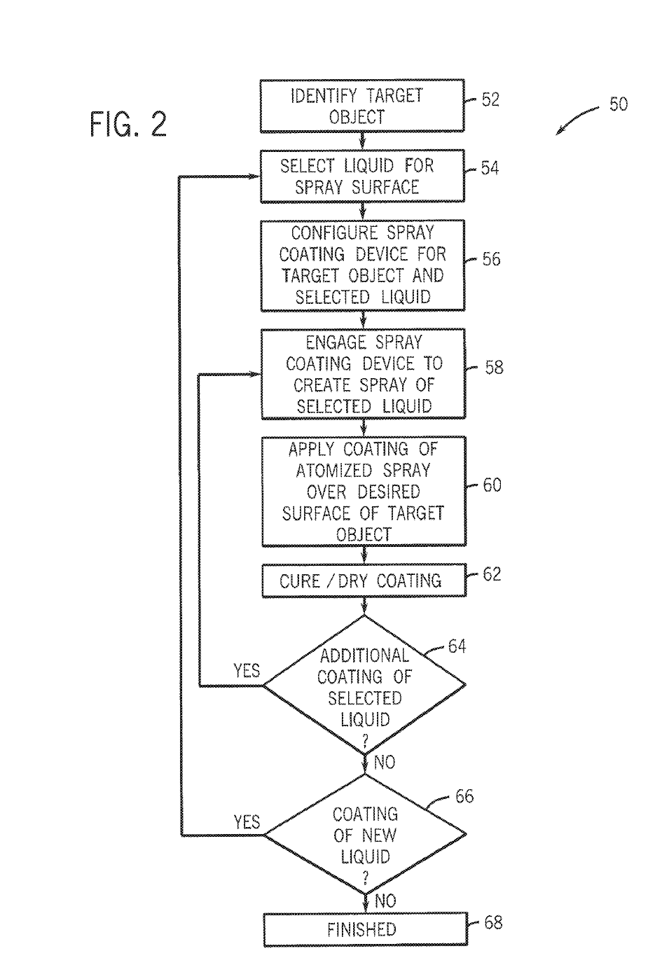

FIG. 2 is a flow chart of a spray coating process 50 for applying a desired spray coating liquid to the target object 14. As illustrated, the process 50 proceeds by identifying the target object 14 for application of the desired liquid (block 52). The process 50 then proceeds by selecting the desired liquid 40 for application to a spray surface of the target object 14 (block 54). A user may then proceed to configure the spray tool 12 for the identified target object 14 and selected liquid 40 (block 56). As the user engages the spray tool 12, the process 50 then proceeds to create an atomized spray of the selected liquid 40 (block 58). The user may then apply a coating of the atomized spray over the desired surface of the target object 14 (block 60). The process 50 then proceeds to cure/dry the coating applied over the desired surface (block 62). If an additional coating of the selected liquid 40 is desired by the user at query block 64, then the process 50 proceeds through blocks 58, 60, and 62 to provide another coating of the selected liquid 40. If the user does not desire an additional coating of the selected liquid at query block 64, then the process 50 proceeds to query block 66 to determine whether a coating of a new liquid is desired by the user. If the user desires a coating of a new liquid at query block 66, then the process 50 proceeds through blocks 54, 56, 58, 60, 62, and 64 using a new selected liquid for the spray coating. If the user does not desire a coating of a new liquid at query block 66, then the process 50 is finished at block 68.

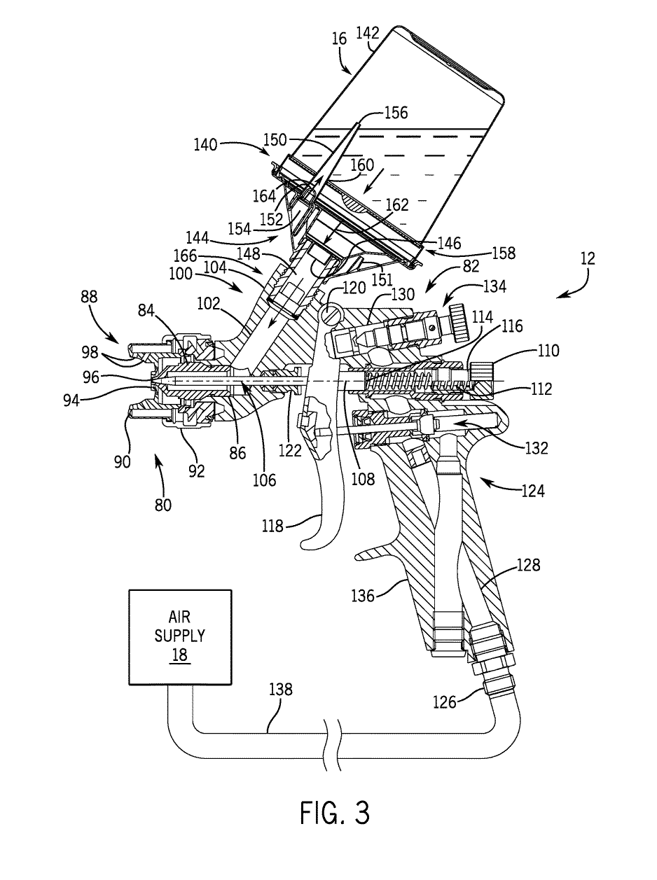

FIG. 3 is a cross-sectional side view of an embodiment of the spray tool 12 coupled to the liquid supply 16. In the illustrated embodiment, the spray tool 12 is a gravity feed spray tool. However, as noted above, the disclosed embodiments are also applicable to other types of spray tools 12, such as siphon-feed spray tools. As illustrated, the spray tool 12 includes a spray tip assembly 80 coupled to a body 82. The spray tip assembly 80 includes a liquid delivery tip assembly 84, which may be removably inserted into a receptacle 86 of the body 82. For example, a plurality of different types of spray tools may be configured to receive and use the liquid delivery tip assembly 84. The spray tip assembly 80 also includes a spray formation assembly 88 coupled to the liquid delivery tip assembly 84. The spray formation assembly 88 may include a variety of spray formation mechanisms, such as air atomization, rotary atomization, and electrostatic mechanisms. However, the illustrated spray formation assembly 88 comprises an air atomization cap 90, which is removably secured to the body 82 via a retaining nut 92. The air atomization cap 90 includes a variety of air atomization orifices, such as a central atomization orifice 94 disposed about a liquid tip exit 96 from the liquid delivery tip assembly 94. The air atomization cap 90 also may have one or more spray shaping air orifices, such as spray shaping orifices 98, which use air jets to force the spray to form a desired spray pattern (e.g., a flat spray). The spray formation assembly 88 also may include a variety of other atomization mechanisms to provide a desired spray pattern and droplet distribution.

The body 82 of the spray tool 12 includes a variety of controls and supply mechanisms for the spray tip assembly 80. As illustrated, the body 82 includes a liquid delivery assembly 100 having a liquid passage 102 extending from a liquid inlet coupling 104 to the liquid delivery tip assembly 84. The liquid delivery assembly 100 also includes a liquid valve assembly 106 to control liquid flow through the liquid passage 102 and to the liquid delivery tip assembly 84. The illustrated liquid valve assembly 106 has a needle valve 108 extending movably through the body 82 between the liquid delivery tip assembly 84 and a liquid valve adjuster 110. The liquid valve adjuster 110 is rotatably adjustable against a spring 112 disposed between a rear section 114 of the needle valve 108 and an internal portion 116 of the liquid valve adjuster 110. The needle valve 108 is also coupled to a trigger 118, such that the needle valve 108 may be moved inwardly away from the liquid delivery tip assembly 84 as the trigger 118 is rotated counter clockwise about a pivot joint 120. However, any suitable inwardly or outwardly openable valve assembly may be used within the scope of the present technique. The liquid valve assembly 106 also may include a variety of packing and seal assemblies, such as packing assembly 122, disposed between the needle valve 108 and the body 82.

An air supply assembly 124 is also disposed in the body 82 to facilitate atomization at the spray formation assembly 88. The illustrated air supply assembly 124 extends from an air inlet coupling 126 to the air atomization cap 90 via air passages 128 and 130. The air supply assembly 124 also includes a variety of seal assemblies, air valve assemblies, and air valve adjusters to maintain and regulate the air pressure and flow through the spray tool 12. For example, the illustrated air supply assembly 124 includes an air valve assembly 132 coupled to the trigger 118, such that rotation of the trigger 118 about the pivot joint 120 opens the air valve assembly 132 to allow air flow from the air passage 128 to the air passage 130. The air supply assembly 124 also includes an air valve adjustor 134 to regulate the air flow to the air atomization cap 90. As illustrated, the trigger 118 is coupled to both the liquid valve assembly 106 and the air valve assembly 132, such that liquid and air simultaneously flow to the spray tip assembly 80 as the trigger 118 is pulled toward a handle 136 of the body 82. Once engaged, the spray tool 12 produces an atomized spray with a desired spray pattern and droplet distribution.

In the illustrated embodiment of FIG. 3, the air supply 18 is coupled to the air inlet coupling 126 via air conduit 138. Embodiments of the air supply 18 may include an air compressor, a compressed air tank, a compressed inert gas tank, or a combination thereof. In the illustrated embodiment, the liquid supply 16 is directly mounted to the spray tool 12. The illustrated liquid supply 16 includes a container assembly 140, which includes a cup or container 142 and a lid or cover portion 144. In some embodiments, the cup 142 may be a flexible cup made of a suitable paper and/or plastic material, such as polypropylene. Furthermore, the cup 142 may be disposable, such that a user may discard the cup 142 after use. The lid 144 includes a liquid outlet 146 coupled to a liquid conduit 148, and a vent tube 150. The vent tube includes a one-way valve 152 (e.g., check valve) disposed between a vent inlet 154 and a vent outlet 156. The cup 142 includes a filter assembly 158 removably mounted inside of the cup 142 and outside of the lid 144 to filter out and block unwanted particles in liquid (e.g., liquid paint mixture) from entering the spray tool 12. The filter assembly 158 includes a tube opening 160 through the filter 200 to accommodate/allow the vent tube 150 expending through the tube opening 160 into the interior of the cup 142 when the lid 144 is closed/fitted on a mouth of the cup 142. As will be discussed in further detail below, the filter assembly 158 may be removably mounted inside of the cup 142 and outside of the lid 144 via various configurations and retainers.

In certain embodiments, all or some of the components of the container assembly 140 may be made of a disposable and/or recyclable material, such as a transparent or translucent plastic, a fibrous or cellulosic material, a non-metallic material, or some combination thereof. For example, the container assembly 140 (e.g., the cup 14, the lid 144, or both) may be made entirely or substantially (e.g., greater than 75, 80, 85, 90, 95, 99 percent) from a disposable and/or recyclable material. Embodiments of a plastic container assembly 140 (e.g., the cup 14, the lid 144, or both) include a material composition consisting essentially or entirely of a polymer, e.g., polyethylene. Embodiments of a fibrous container assembly 140 (e.g., the cup 14, the lid 144, or both) include a material composition consisting essentially or entirely of natural fibers (e.g., vegetable fibers, wood fibers, animal fibers, or mineral fibers) or synthetic/man-made fibers (e.g., cellulose, mineral, or polymer). Examples of cellulose fibers include modal or bamboo. Examples of polymer fibers include nylon, polyester, polyvinyl chloride, polyolefins, aramids, polyethylene, elastomers, and polyurethane. In certain embodiments, the cup 142 may be designed for a single use application (although the cup 142 may still be used for a limited number of uses such as 1, 2, 3, 4, 5, 6, 7, 8, 9, or 10 uses), whereas the lid 144 may be non-disposable and/or designed for unlimited use. In other embodiments, the lid 144 may be designed for a single use application (although the lid 144 may still be used for a limited number of uses such as 1, 2, 3, 4, 5, 6, 7, 8, 9, or 10 uses), whereas the cup 142 may be non-disposable and/or designed for unlimited use. In other embodiments, the cup 142 and the lid 144 may both be disposable and may be designed for a single use or limited uses before being discarded.

As further illustrated in FIG. 3, the container assembly 140 is coupled to the spray tool 12 overhead in a gravity feed configuration. During setup, the cup 142 may be filled or pre-filled with a coating liquid (e.g., paint) in an open side up position separate from the spray tool 12. If the cup 142 is prefilled and sealed with a coating liquid, then the setup may involve unsealing the cup 142 (e.g., removing a temporary or storage cover), installing the filter assembly 158 inside the cup 142, and then installing the lid 144. However, in certain embodiments, the filter assembly 158 may be pre-installed inside the sealed cup 142 prior to setup with the lid 142. In certain embodiments, the coating liquid may be premixed prior to filling the cup 142 or the coating liquid may be mixed within the cup 142, followed by installation of the filter assembly 158 in the cup, and the installation of the lid 144 onto the cup 142. In certain embodiments, the coating liquid may be supplied into the cup 142 with the filter assembly 158 already mounted inside of the cup 142, for example, by pouring the coating liquid through the tube opening 160 of the filter assembly 158. Regardless of the setup type, the assembled cup 142, lid 144, and filter assembly 158 (e.g., the container assembly 140) may then be coupled directly to the spray tool 12.

The connection with the spray tool 12 may be made through an adapter 166 coupled to the lid 144 via a lock mechanism, such as a threaded connection, a protrusion disposed in a spiral groove, a snap fit connection, an interference fit connection, or any combination thereof. For example, the lock mechanism may include a positive lock mechanism (e.g., radial protrusion) disposed on the exterior surface of the liquid conduit 148, and a mating lock mechanism (e.g., radial recess) disposed on the interior surface of the adapter 166. As the cup 142 is flipped over, a portion the coating liquid may partially enter the vent tube 150, but the check valve 152 blocks any further flow of the liquid. During use of the spray tool 12, the coating liquid flows from the cup 142, where the coating liquid is filtered by the filter assembly 158, and then subsequently flows through the lid 144 and into the spray tool 12 along a fluid flow path 162. Concurrently, air enters the cup 142 via an air flow path 164 through the vent tube 150.

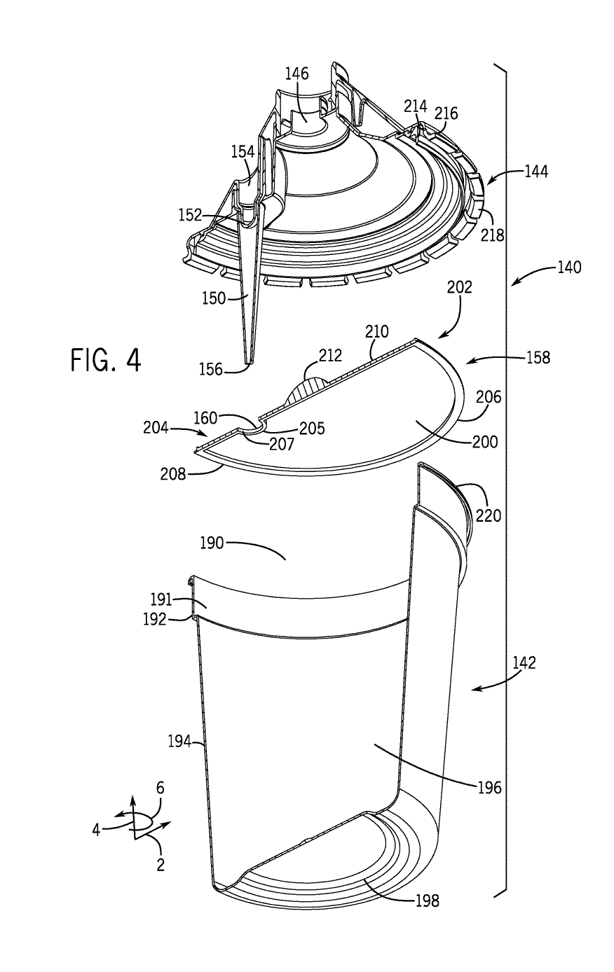

FIG. 4 is a cutaway partial exploded perspective view of an embodiment of the container assembly 140 of FIG. 3, illustrating the cup 142, the lid 144, and the filter assembly 158 exploded from one another. In the illustrated embodiment, the container assembly 140 includes the cup 142, the filter assembly 158 inside of the cup 142, and the lid 144. The cup 142 includes a top opening 190, an annular shoulder 192, a sidewall 194 (e.g., annular side wall), a fluid chamber 196, and a bottom wall 198. As discussed above, the cup 142 may be a disposable cup or a reusable cup. The cup 142 also may have an annular interior surface 191 (e.g., a cylindrical or tapered/conical surface) between the top opening 190 and the annular shoulder 192, thereby facilitating retention of the filter assembly 158. The surface 191 may be entirely smooth between the top opening 190 and the annular shoulder 192 (e.g., no threads, no recesses, no ribs, etc.), thereby facilitating a friction fit or interference fit. However, in some embodiments, the surface 191 may include additional retention features, such as snap-fit features (e.g., protrusions and/or grooves), to facilitate mounting of the filter assembly 158.

The filter assembly 158 may include a filter 200 retained in the filter assembly 158 by a first retainer 202 and supported by a support structure 204. In certain embodiments, the filter 200 may be a separate removable component relative to the first retainer 202 and/or support structure 204. However, in some embodiments, the filter 200 may be fixedly secured to and/or integrally formed with the first retainer 202 and/or support structure 204. The filter 200 may include one or more filter layers or filter elements (e.g., 1, 2, 3, 4, 5, 6, 7, 8, 9, 10, or more layers of stacked filters), such as parallel filter elements of the same or different characteristics. The first retainer 202 may include a first retainer ring 206 to retain the filter 200 at a circumferential edge. The support structure 204 may include an outer support 208 (e.g., annular support, rib, or brace) to support the filter 200 at the circumferential edge, and a center support 210 (e.g., linear support, rib, or brace) extending across the filter 200. In certain embodiments, the support structure 204 may include more than one center support 210 (e.g., 2, 3, 4, 5, 6, 7, 8, 9, or 10 supports) extending across the filter 200 in parallel rows, crosswise rows (e.g., a grid), or any combination thereof.

The center support 210 may further include one or more gripping structures 212 for gripping (e.g., a user finger grip). The gripping structure 212 may allow for easy removal of the filter assembly 158 (e.g., a tab, extended rib, loop, or arcuate structure that provides a place to grab). The illustrated gripping structure 212 is disposed in a central region of the filter assembly 158; however, one or more gripping structures 212 may be disposed in central and/or peripheral portions of the filter assembly 158 (e.g., along the outer support 208).

The filter assembly 158 also includes the tube opening 160 through a portion of the support structure 204 (e.g., an annular support portion 205). Again, the tube opening 160 is configured to receive and seal with the vent tube 150 of the lid 144, and also may be used to supply liquid coating material into the cup 142 while the filter assembly 158 is installed in the cup 142. The tube opening 160 may include one or more seals 207 (e.g., annular seals) in the annular support portion 205. For example, the seals 207 may include elastomeric o-rings disposed in annular grooves within the support portion 205, annular ribs integrally formed within the support portion 205, or the support portion 205 itself may define an integral seal 207 (e.g., support structure 204 made of a plastic material to define a friction seal against vent tube 150).

The lid 144 includes the fluid outlet 146, the vent tube 150, an inner wall 214 (e.g., inner annular wall), and an outer wall 216 (e.g., outer annular wall). The vent tube 150 includes the check valve 152 disposed between the vent inlet 154 and the vent outlet 156. The outer wall 216 further includes a mount or coupling 218 (e.g., a snap fit interface 218) to allow the lid 144 to be removably coupled to the cup 142 when the lid 144 is disposed on top and axially abuts a mouth 220 of the cup 142. In some embodiments, the coupling 218 may include a threaded coupling, a clamped coupling, a latched coupling, or any combination thereof.

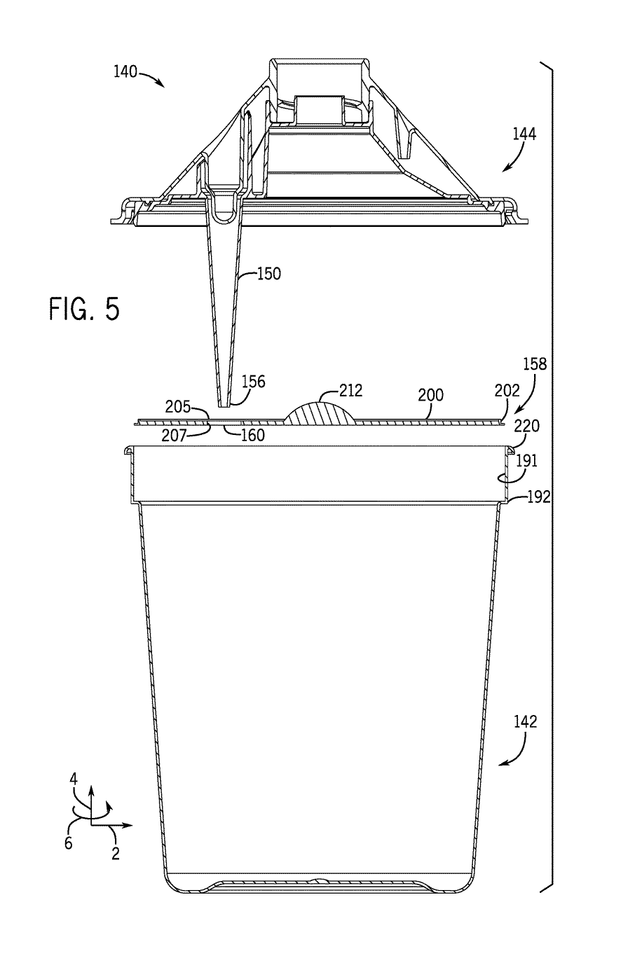

FIG. 5 is a cross-sectional side exploded view of an embodiment of the container assembly 140 of FIG. 3 prior to assembly, illustrating the lid 144, the filter assembly 158, and the cup 142 exploded from one another. The filter assembly 158 is disposed above the cup 142 in the axial direction while the circumferences of the filter assembly 158 and the mouth 220 of the cup 142 are approximately concentrically aligned. The lid 144 is disposed above the filter assembly 158 in the axial direction while the circumferences of the lid 144 and the filter assembly 158 are approximately concentrically aligned, and the vent tube 150 and the tube opening 160 are coaxially aligned in the axial direction with the vent outlet 156 resting above the tube opening 160. As such the lid 144, the filter assembly 158 and the cup 142 are in their respective positions ready for assembling.

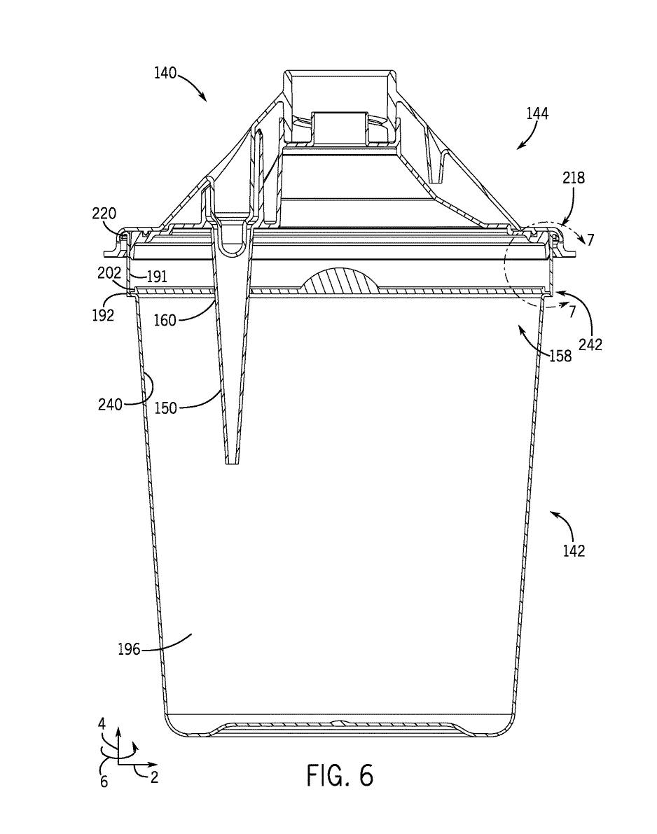

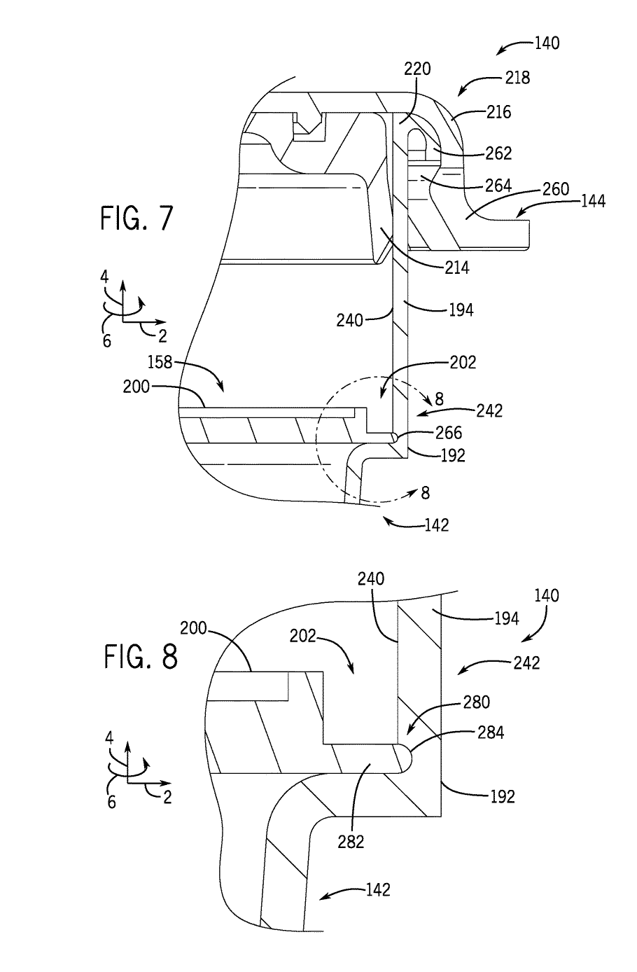

FIG. 6 is a cross-sectional side view of an embodiment of the container assembly 140 of FIG. 3 after assembly, illustrating the filter assembly 158 removably mounted inside of the cup 142 and outside of the lid 144, and the lid 144 coupled to the cup 142. The filter assembly 158 is disposed on top and axially abuts the annular shoulder 192, and is removably mounted inside of the cup 142 and outside of the lid 144 via a mounting interface 242. The mounting interface 242 may include an outer radial end or peripheral edge of the filter assembly 158 (e.g., the first retainer 202) contacting an inner surface 240 (e.g., surface 191) of the cup 142 creating a snap fit interface, a friction fit interface, or an interference fit interface, which will be discussed in further detail below in FIGS. 7-12. The lid 144 is disposed on top and axially abuts the mouth 220 of the cup 142 with the vent tube 150 extending into the fluid chamber 196 though the tube opening 160, and the vent tube 150 seals within the tube opening 160 via the seal 207 in the annular support portion 205. In the illustrated embodiment, the vent tube 150 has a tapered annular tube (e.g., conical tube) that fits within the support portion 205, thereby facilitating a compression seal with the seal 207. The coupling between the lid 144 and the cup 142 may be achieved via the coupling 218 (e.g., snap fit interface 218), which will be discussed in further detail in FIG. 7.

FIG. 7 is a partial cross-sectional view of an embodiment of the container assembly 140 of FIG. 6 taken within line 7-7, illustrating the removably coupled lid 144 and the cup 142, and the filter assembly 158 removably mounted inside of the cup 142 and outside of the lid 144. In the illustrated embodiment, the outer wall 216 of the lid 144 may include a plurality of snap fit protrusions 260 that extend radially inward toward the inner wall 214 into an annular space 215 between the inner and outer walls 214 and 216. The mouth 220 of the cup 142 may include a snap fit lip 262 that protrudes radially outward and create a snap fit recess 264 configured to receive the snap fit protrusions 260. For example, the sidewall 194 of the cup 144 may be axially inserted into the annular space 215 between the inner and outer walls 214 and 216 of the lid 144, such that the sidewall 194, snap fit lip 262, and snap fit recess 264 are disposed in the annular space 215 with the snap fit protrusions 260 in the snap fit recess 264 below the snap fit lip 262. In this manner, the sidewall 194 is compressively fit between the inner and outer walls 214 and 216, and the snap fit protrusions 260 snap into the snap fit recess 264 to positively lock the lid 144 onto the cup 144.

Further, in the illustrated embodiment, the filter assembly 158 is removably mounted inside of the cup 142, on top and axially abutting the annular shoulder 192, and outside of the lid 144. Specifically, the first retainer 202, retaining the filter 200, is disposed on top and axially abuts the annular shoulder 192, and is removably mounted inside of the cup 142 and outside of the lid 144 via the mounting interface 242. For example, the mounting interface 242 is between an outer surface 266 (e.g., annular outer surface) of the first retainer 202 and the inner surface 240 (e.g., annular interior surface 191) of the cup 142. Further, the mounting interface 242 may include a snap-fit interface, a friction-fit interface, or an interference-fit interface, which will be discussed in further detail in FIGS. 8-12.

FIG. 8 is a partial cross-sectional view of an embodiment of the container assembly 140 of FIG. 7 taken within line 8-8, illustrating an embodiment of the mounting interface 242. Specifically, the mounting interface 242 may include a snap fit interface 280 with one or more snap fit features. The snap fit interface 280 may include the first retainer 202 having a radial protrusion 282 (e.g., annular protrusion, or radially protruding ring, lip, or finger), and the sidewall 194 of the cup 142 having a corresponding radial recess 284 (e.g., annular recess) on the inner surface 240, axially above and abutting the shoulder 192. The radial protrusion 282 may be configured to be received by the radial recess 284, such that the contacting area between the radial protrusion 282 and the radial recess 284 forms the snap fit interface 280. The snap fit interface 280 may serve as the mounting interface 242, such that the filter assembly 158 is removably mounted inside of the cup 142 and outside of the lid 144 (see FIG. 7). In some embodiments), the snap fit interface 280 may include the first retainer 202 having a plurality of radial protrusions 282, which may be received by a corresponding plurality of radial recesses 284 on the inner surface 240 and axially above the shoulder 192 of the cup 142. In some embodiments, the snap fit interface 280 may include a reversed configuration of protrusions and recesses, wherein the protrusions 282 are disposed on the inner surface 240 while the recesses 284 are disposed on the first retainer 202. In some embodiments, the snap fit interface 280 may include both protrusions 282 and recesses 284 on both the inner surface 240 and the first retainer 202.

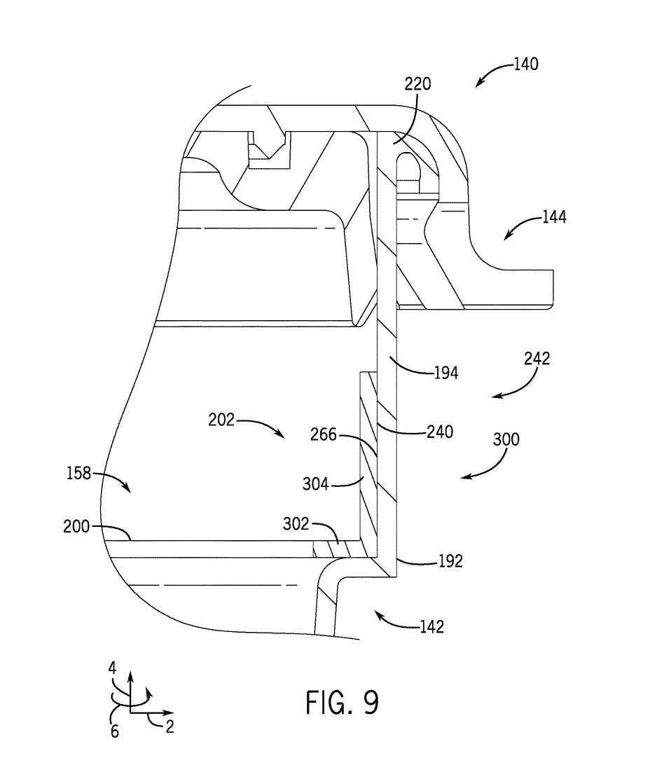

FIG. 9 is a partial cross-sectional view of an embodiment of the container assembly 140 of FIG. 6 taken within line 7-7, illustrating an embodiment of the mounting interface 242. Specifically, the mounting interface 242 may include a friction fit interface 300. The friction fit interface 300 may include the first retainer 202 having a first portion 302 (e.g., first annular portion or base portion) and a second portion 304 (e.g., second annular portion or extension portion). The first portion 302 may be configured to retain the filter 200, and may be disposed on top and axially abutting the annular shoulder 192 inside of the cup 142. The first portion 302 may transition to the second portion 304 above the shoulder 192. For example, the second portion 304 may extend above the annular shoulder 192 toward a main opening (e.g., the mouth 220) in the cup 142, and end at a location below the lid 144 (e.g., the second portion 304 does not touch or extend into any portion of the lid 144). The outer surface 266 of the second portion 304 contacts the inner surface 240 of the sidewall 194 of the cup 142, and the contact area forms the friction fit interface 300. The friction fit interface 300 may serve at least partially or entirely as the mounting interface 242 to removably mount the filter assembly 158 inside of the cup 142 and outside of the lid 144. In certain embodiments, one or both of the surfaces 266 and 240 defining the friction fit interface 300 may include a smooth annular surface, a textured annular surface with one or more surface textures, and/or non-smooth annular surface having one or more protrusions, recesses, or a combination thereof.

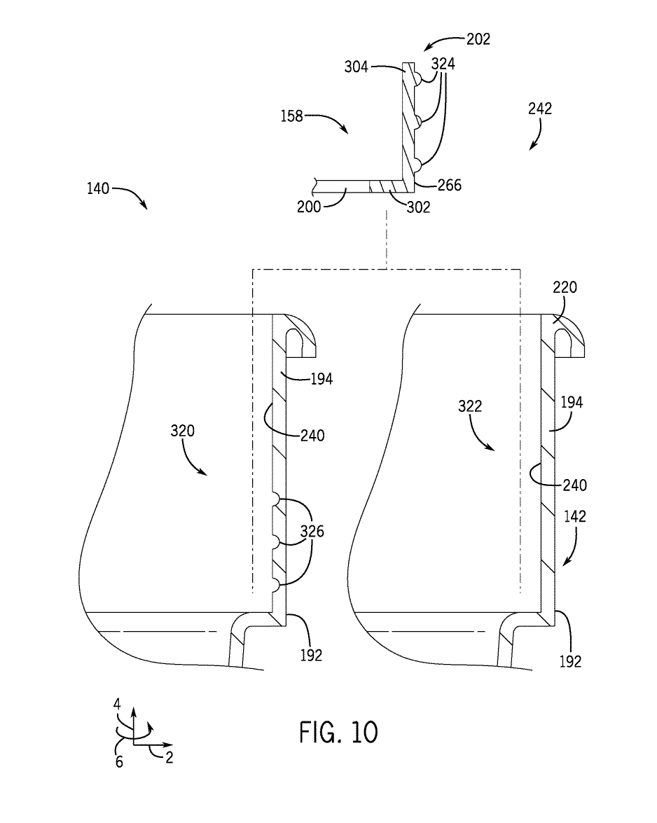

FIG. 10 is a partial cross-sectional view of an embodiment of the container assembly 140 of FIG. 9, illustrating additional retention features of the mounting interface 242. The first retainer 202 may include the first portion 302 and the second portion 304. The first portion 302 may be configured to retain the filter 200, and may be disposed on top and axially abutting the annular shoulder 192 inside of the cup 142. The second portion 304 may extend above the annular shoulder 192 toward a main opening in the cup 142 (e.g., the mouth 220). Specifically, in certain embodiments, the mounting interface 242 may include a snap fit interface 320 shown on the left side of FIG. 10, a friction fit or interference fit interface 322 shown on the right side of FIG. 10, or a combination thereof.

The snap fit features of the snap fit interface 320 may include the first retainer 202 having a plurality of radial protrusions 324 (e.g., annular protrusions) along the second portion 304 on the outer surface 266. Correspondingly, the sidewall 194 of the cup 142 may have a plurality of radial recesses 326 (e.g., annular recesses) on the inner surface 240. Alternatively or additionally, the plurality of radial protrusions 324 may be on the inner surface 240 of the sidewall 194 while the corresponding plurality of radial recesses 326 may be on the outer surface 266 along the second portion 304 of the first retainer 202. In either configuration or a combination thereof, the corresponding plurality of radial recesses 326 are configured to receive the plurality of radial protrusions 324, such that the contact area between the snap fit features forms the snap fit interface 320. The snap fit interface 320 may serve at least partially or entirely as the mounting interface 242 to removably mount the filter assembly 158 inside of the cup 142 and outside of the lid 144. However, in some embodiments, the snap fit interface 320 may be combined with the friction fit interface 300 of FIG. 9, the interference fit interface 322 of FIG. 10, or a combination thereof.

The interference fit interface 322 is shown on the right side of FIG. 10, and may be used alone or in combination with other retention features disclosed herein. The interference fit features of the interface 322 may include the first retainer 202 having a plurality of radial protrusions 324 (e.g., annular protrusions) along the second portion 304 on the outer surface 266. However, the sidewall 194 of the cup 142 may be without any protrusions or recesses (e.g., a relatively smooth annular surface). The plurality of radial protrusions 324 contacts the inner surface 240 of the sidewall 194, forming the interference fit interface 322, which may serve at least partially or entirely as the mounting interface 242 to removably mount the filter assembly 158 inside of the cup 142 and outside of the lid 144 (see FIG. 9). Alternatively or additionally, the plurality of radial protrusions 324 may be on the inner surface 240 of the sidewall 194 while the outer surface 266 along the second portion 304 of the first retainer 202 is substantially smooth (e.g., smooth annular surface).

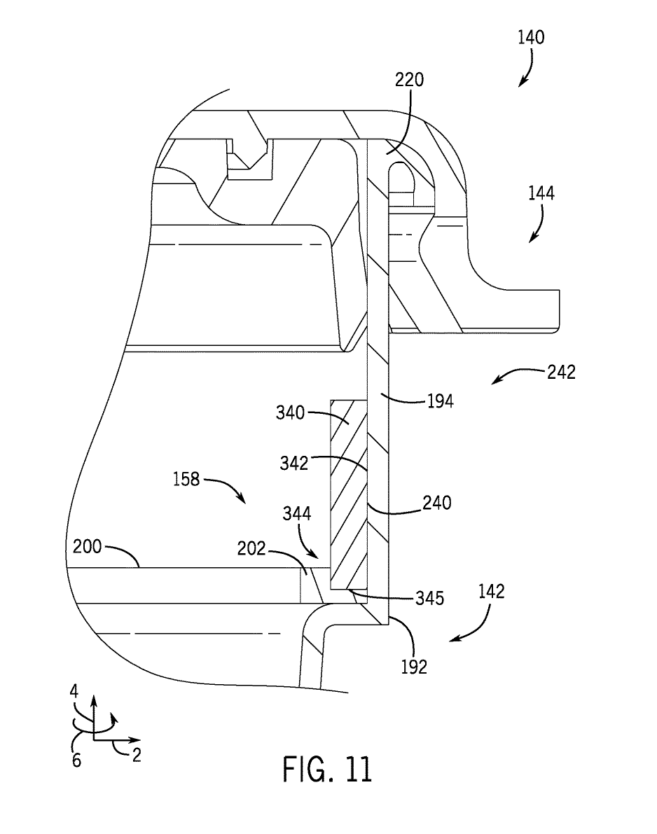

FIG. 11 is a partial cross-sectional view of an embodiment of the container assembly 140 of FIG. 9, illustrating an embodiment of the mounting interface 242. The filter assembly 158 may include the first retainer 202 and a separate second retainer 340 (e.g., the first retainer 202 and the second retainer 340 are separate from each other). The first retainer 202 may be configured to retain the filter 200 and is disposed on top and abutting the annular shoulder 192 inside of the cup 142. The second retainer 340 (e.g., an annular retainer, lock ring, or hold down ring) may be configured to retain the first retainer 202. Specifically, the second retainer 340 may be disposed on top of and abutting the first retainer 202, and extends above the annular shoulder 192 toward a main opening (e.g., the mouth 220) in the cup 142, and ends at a location below the lid 144 (e.g., the second retainer 340 does not extend into or contact any portion of the lid 144). The second retainer 340 may be configured to contact the first retainer 202 via a retaining portion 344, which may be disposed in a recess 345 (e.g., annular recess) in the first retainer 202. The retaining portion 344 may be removably coupled to the recess 345 via a press-fit, interference fit, snap-fit, or a loose fit.

Further, the second retainer 340 may be configured to contact the inner surface 240 of the sidewall 194 to create the mounting interface 342. The mounting interface 342 may be any of the friction fit interface 300, the interference fit interface 322, or the snap fit interface 280 or 320 (e.g., snap fit features include at least one radial protrusion and corresponding recess), or any combination thereof, as described in detail above. As such, the first retainer 202 may be retained by the second retainer 340, while the second retainer 340 may form the mounting interface 342 with the cup 142 to removably mount the filter assembly 158 inside of the cup 142 and outside of the lid 144. In certain embodiments, the second retainer 340 may include a lock ring, such as a split lock ring (e.g., a C-ring).

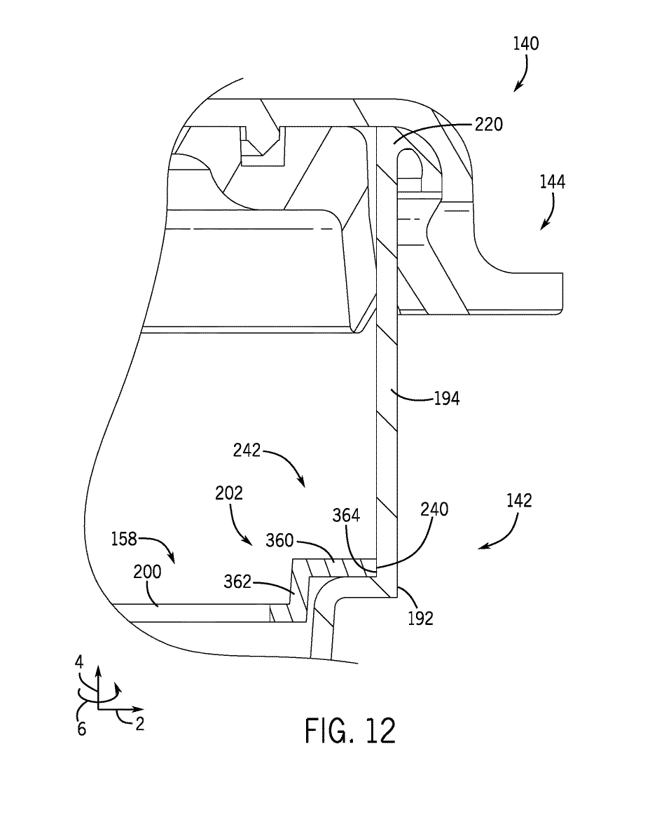

FIG. 12 is a partial cross-sectional view of an embodiment of the container assembly 140 of FIG. 9, illustrating an embodiment of the mounting interface 242. The first retainer 202 may include a first portion 360 (e.g., first annular portion or base portion) and a second portion 362 (e.g., second annular portion or extending portion). The first portion 360 may be disposed on top of and axially abutting the annular shoulder 192 inside of the cup 142. The first portion 360 may transition to the second portion 362 above the shoulder 192, and the second portion 362 may extend axially below the annular shoulder 192 away from a main opening (e.g., the mouth 220) in the cup 142. The second portion 362 may be configured to retain the filter 200 while the first portion 360 may be configured to contact the sidewall 192 of the cup 142 to create the mounting interface 242. Specifically, the first portion 360 may have an outer surface 364 (e.g., outer annular surface), which contacts the inner surface 240 of the sidewall 192, forming the mounting interface 242. The mounting interface 242 may include any of the friction fit interface 300, the interference fit interface 322, or the snap fit interface 280 or 320 (e.g., snap fit features include at least one radial protrusion and corresponding recess), or any combination thereof, as discussed in detail above. As such, the filter assembly 158 may be removably mounted inside of the cup and outside of the lid 144.

As discussed above, the filter assembly 158 may include a variety of configurations and retention features, which may be used alone or in any combination with one another. Thus, any of the features shown and described with reference to FIGS. 1-12 are intended to be used in any combination with one another.

Furthermore, although the disclosed embodiments present the filter assembly 158 mounted inside the cup 142 and outside of the lid 144, some embodiments may include both the filter assembly 158 disposed in the cup 142 and an additional one or more filter assemblies 158 disposed in the lid 144, a fluid flow path, or any combination thereof.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system, comprising:
a cup;
a filter configured to mount inside of the cup; and
a first retainer configured to retain the filter.

2. The system of claim 1, wherein the first retainer comprises a first retainer ring.

3. The system of claim 1, wherein an outer surface of the first retainer is configured to contact an inner surface of the cup to create a friction fit interface.

4. The system of claim 1, wherein the first retainer comprises at least one snap fit structure, and the at least one snap fit structure comprises one or more protrusions, one or more recesses, or a combination thereof.

5. The system of claim 1, comprising a second retainer configured to retain the first retainer, wherein the first and second retainers are separate from one another.

6. The system of claim 1, comprising one or more supports extending across the filter.

7. The system of claim 1, comprising a gripping structure coupled to the filter.

8. The system of claim 1, comprising a tube opening through the filter.

9. The system of claim 8, comprising a vent tube extending through the tube opening.

10. The system of claim 1, comprising a container having a lid removably coupled to the cup, wherein the filter is configured to mount inside of the cup and outside of the lid.

11. The system of claim 10, comprising a spray tool having a fluid inlet coupled to a fluid outlet in the lid.

12. A system, comprising:
a filter configured to mount inside of a cup; and
a first retainer configured to retain the filter.

13. The system of claim 12, wherein the first retainer comprises a first retainer ring.

14. The system of claim 12, wherein an outer surface of the first retainer is configured to contact an inner surface of the cup to create a friction fit interface.

15. The system of claim 12, wherein the first retainer comprises at least one snap fit structure.

16. The system of claim 15, wherein the at least one snap fit structure comprises one or more protrusions, one or more recesses, or a combination thereof.

17. The system of claim 12, wherein the first retainer has a first portion that axially abuts an annular shoulder inside of the cup.

18. The system of claim 17, wherein the first retainer has a second portion that extends below the annular shoulder away from an opening in the cup.

19. The system of claim 17, wherein the first retainer has a second portion that extends above the annular shoulder toward an opening in the cup.

20. The system of claim 12, comprising a second retainer configured to retain the first retainer, wherein the first and second retainers are separate from one another.

21. The system of claim 12, comprising one or more supports extending across the filter.

22. The system of claim 12, comprising a gripping structure coupled to the filter.

23. The system of claim 12, comprising a tube opening through the filter.

24. The system of claim 12, comprising a container having a lid removably coupled to the cup, wherein the filter is configured to mount inside of the cup and outside of the lid.

25. A system, comprising:
a filter;
one or more supports extending across the filter;
a vent tube opening through the filter; and
a first retainer configured to retain the filter.
